(19) United States
(12) Patent Application Publication
(10) Pub. No.: US 2024/0289907 A1
(43) Pub. Date: Aug. 29, 2024

(54) SOCIAL RESOURCE PRESENTING APPARATUS, SOCIAL RESOURCE PRESENTING METHOD AND PROGRAM

(71) Applicant: NIPPON TELEGRAPH AND TELEPHONE CORPORATION, Tokyo (JP)

(72) Inventors: Erika ASHIKAGA, Tokyo (JP); Chihiro YAMAMOTO, Tokyo (JP)

(21) Appl. No.: 18/565,271

(22) PCT Filed: Jun. 15, 2021
(86) PCT No.: PCT/JP2021/022736

§ 371 Date: Nov. 29, 2023

(51) Int. Cl. G06Q 50/22

(52) U.S. Cl. CPC G06Q 50/22

(57) ABSTRACT

A social resource presentation device includes an input unit configured to receive a request input by a user related to support for promoting social engagement; and an output unit configured to output information indicating a social resource corresponding to characteristics and the request of the user, by which it is possible to easily find out suitable support for promoting social engagement.

### TECHNICAL FIELD

The present invention relates to a social resource presentation device, a social resource presentation method, and a program.

### BACKGROUND ART

Professional social workers who support care recipients such as the elderly population infer the personality of the care recipient based on their physical condition and, further, narrative disclosed in conversation with them, and propose suitable support for promoting social engagement considering the estimated personality.

### CITATION LIST

### Non Patent Literature

[NPL 1] “Analysis of Care Recorded Contents Using TETDM,”, Kushima M, Araki K, Suzuki M, Yamazaki T, Sonehara N, Japan Association of Medical Informatics, Spring Conference Paper, 35 (5) 229-238, 2015.

### SUMMARY OF INVENTION

### Technical Problem

However, such a proposal is dependent on individual skills and expertise, and possible only for professional social workers, and it has been difficult for care recipients and their families to easily find support for promoting social engagement.

The present invention has been made to solve the problems described above, and an object thereof is to easily find out proper support for promoting social engagement.

### Solution to Problem

Therefore, in order to solve the problems above, provided is a social resource presentation device including an input unit configured to accept an input of a request from a certain person regarding support for promoting social engagement; and an output unit configured to output information indicating the characteristics of the certain person and the social resources corresponding to the request.

### Advantageous Effects of Invention

It is possible to enable anyone to easily find out proper support for promoting social engagement.

### BRIEF DESCRIPTION OF DRAWINGS

FIG. 1 is a diagram illustrating a hardware configuration example of a social resource presentation device 10 according to an embodiment of the present invention.

FIG. 2 is a diagram illustrating a functional configuration example of the social resource presentation device 10 according to the embodiment of the present invention.

FIG. 3 is a diagram illustrating one example of personal data.

FIG. 4 is a diagram illustrating a displaying example of a screen for receiving answers for narrative items.

FIG. 5 is a diagram illustrating an example of adding a narrative item necessary for promoting social engagement to the personal data.

FIG. 6 is a diagram illustrating a configuration example of an expert data storage unit 112.

FIG. 7 is a diagram illustrating an example of adding “Personality” to the personal data.

FIG. 8 is a diagram illustrating a first example of social resource data.

FIG. 9 is a diagram illustrating a second example of social resource data.

FIG. 10 is a flowchart illustrating one example of processing procedures of social resource match processing in response to a request from a care recipient A.

FIG. 11 is a diagram illustrating a configuration example of a query.

### DESCRIPTION OF EMBODIMENTS

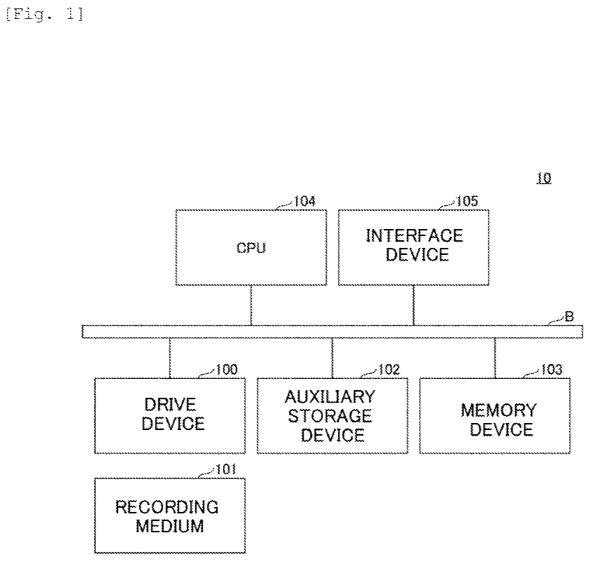

Embodiments of the present invention will be described below with reference to the drawings. FIG. 1 is a diagram illustrating a hardware configuration example of a social resource presentation device 10 according to an embodiment of the present invention. The social resource presentation device 10 in FIG. 1 includes, for example, a drive device 100, an auxiliary storage device 102, a memory device 103, a CPU 104, and an interface device 105, which are connected to each other via a bus B.

A program which implements processing in the social resource presentation device 10 is provided using a recording medium 101 such as a CD-ROM. When the recording medium 101 storing the program is set in the drive device 100, the program is installed from the recording medium 101 to the auxiliary storage device 102 via the drive device 100. However, the program does not necessarily have to be installed from the recording medium 101 and may be downloaded from another computer via a network. The auxiliary storage device 102 stores the installed program as well as, for example, necessary files and data.

The memory device 103 reads and stores the program from the auxiliary storage device 102 when an instruction for initiating the program is issued. The CPU 104 executes a function relating to the social resource presentation device 10 in accordance with the program stored in the memory device 103. The interface device 105 is used as an interface to connect to a network.

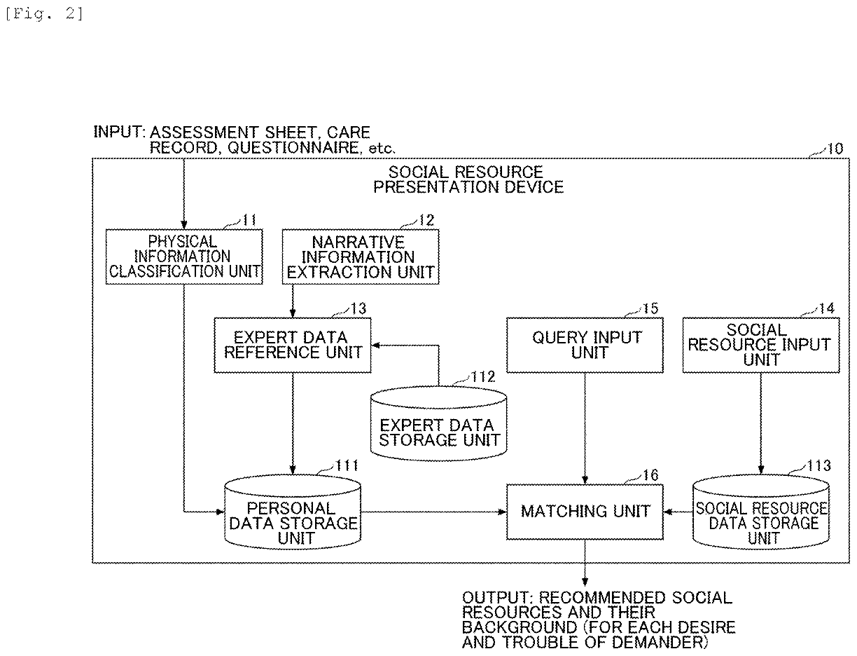

FIG. 2 is a diagram illustrating a functional configuration example of the social resource presentation device 10 according to the embodiment of the present invention. In FIG. 2, the social resource presentation device 10 includes a physical information classification unit 11, a narrative information extraction unit 12, an expert data reference unit 13, a social resource input unit 14, a query input unit 15, and a matching unit 16. The respective units are implemented by processing of the CPU 104 to execute one or more programs installed in the social resource presentation device 10. The social resource presentation device 10 also adopts storage units, such as a personal data storage unit 111, an expert data storage unit 112, and a social resource data storage unit 113. These storage units can be implemented by using, for example, the auxiliary storage device 102 or a storage device connectable to the social resource presentation device 10 via a network.

In the present embodiment, a specific care recipient (“care recipient A”) will be described hereinbelow as one example of a user who needs support for promoting social engagement; however, the same processing may be executed for each of several care recipients. Further, the present embodiment may be applied to a person other than a care recipient. For example, although a user is not a care recipient, this embodiment may be applied to them if they need social support (i.e. people whose mental and physical health is affected by social isolation).

[Physical Information Classification Unit 11] The physical information classification unit 11 receives documents, such as assessment sheets, care records and questionnaires, in related with the care recipient A as input information. The input information is created by an expert who is a caregiver for the care recipient A, for example, care coordinator, day-care provider or rehabilitation specialist. The input information includes an item name and a value for each item. The physical information classification unit 11 classifies respective items of the input information into “Basic Information”, “Psychosomatic Functions and Body Structure”, “Activities”, “Engagement” and “Environment” based on the item name.

Examples of item names classified as the “Basic Information” category include name, sex, address and number of households.

Examples of item names classified as “Psychosomatic Functions and Body Structure” category include a medical history, conditions, medicines taking, type of disability, paralyzed body parts and defective body parts.

Examples of item names classified as “Activities” category include ADLs (activities of daily living; including but not limited to ambulating, walking, standing, rolling over, continence, toileting, hearing, communication, vision, feeding, personal hygiene [bathing, grooming, dental hygiene, nail and hair care], and dressing) and IADLs (instrument ADLs; including but not limited to meal preparation, washing, transportation and shopping, housecleaning and home maintenance, managing medications, managing finances, and managing communication). Item values for those item names belonging to the “Activities” category are values indicating a level of the ability to perform an activity represented by any of the item names.

Examples of item names classified as “Engagement” category include service usage status and regional activity status.

Examples of item names classified as “Environment” category include residence environment, ADLs/IADLs of family, request of the family, opinions of the person concerned, relationship with the neighborhood, and items affecting daily life.

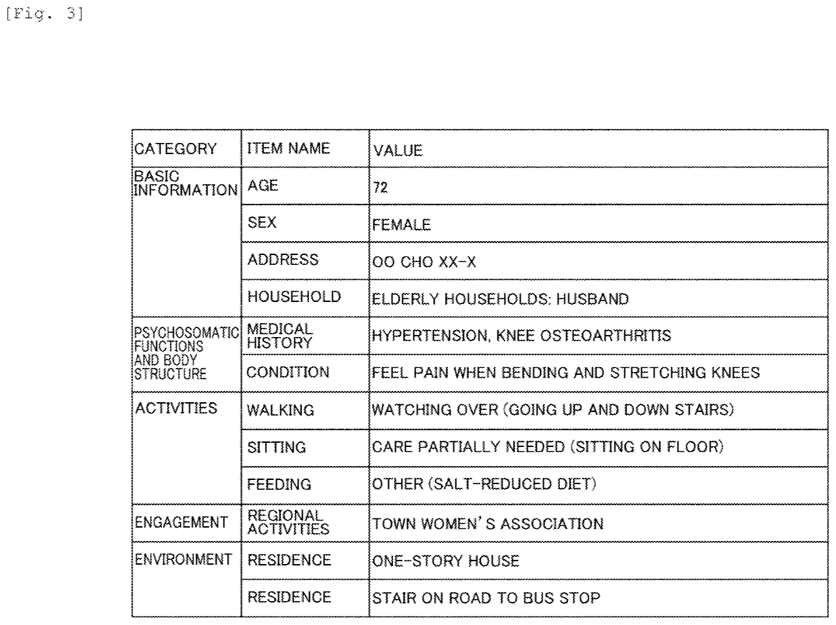

The physical information classification unit 11 extracts an item (item name and value) having an item name corresponding to any one of the item names from input information, and classifies the item into any one of the categories in accordance with the classification rule described above. The physical information classification unit 11 stores the classification results in the personal data storage unit 111 as personal data of the care recipient A. FIG. 3 is a diagram illustrating one example of personal data.

### [Narrative Information Extraction Unit 12]

The narrative information extraction unit 12 accepts, for each of items (hereinafter refers to as “narrative item (s)”) predefined with respect to narratives necessary for promoting social engagement (defined as episodes in life that form a person's sense of values), an answer to which the care recipient A corresponds regarding a value of the narrative item. Examples of the narrative items include:
Items of ability and experience: Job, type of occupation (role), what they are learning, and place of birth
Items of hobby and preference: Hobby and special skills (what such a person is good at)
Item of relationship: Family and close friends (people living in the neighborhood, friends in the same club or old friends), and places where they often visit These items may be defined, for example, based on conversations with experts (e.g. care coordinators, day-care providers or rehabilitation specialists).

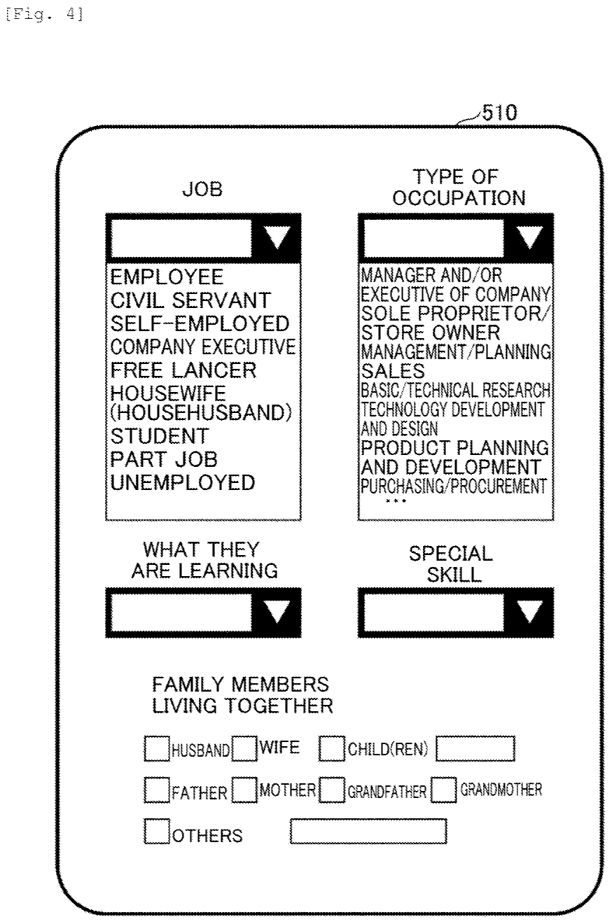

FIG. 4 is a diagram illustrating a displaying example of a screen for receiving answers for narrative items. A screen 510 shown in FIG. 4 is a screen for receiving answers for the narrative items, such as job, type of occupation, what they are learning, special skills, and family members living together. The screen 510 shown in FIG. 4 is configured to choose an answer for each narrative item from a predetermined list of answer options. Therefore, a respondent chooses an answer to which the care recipient A corresponds from the list of answer options. The list of answer options may also be prepared on the basis of conversations with the expert, or from the existing questionnaires. The answer may be input by the care recipient A or their family members, or by experts based on conversations with the care recipient A.

The narrative information extraction unit 12 adds the item name and the answer for each narrative item to the personal data of the care recipient A stored in the personal data storage unit 111.

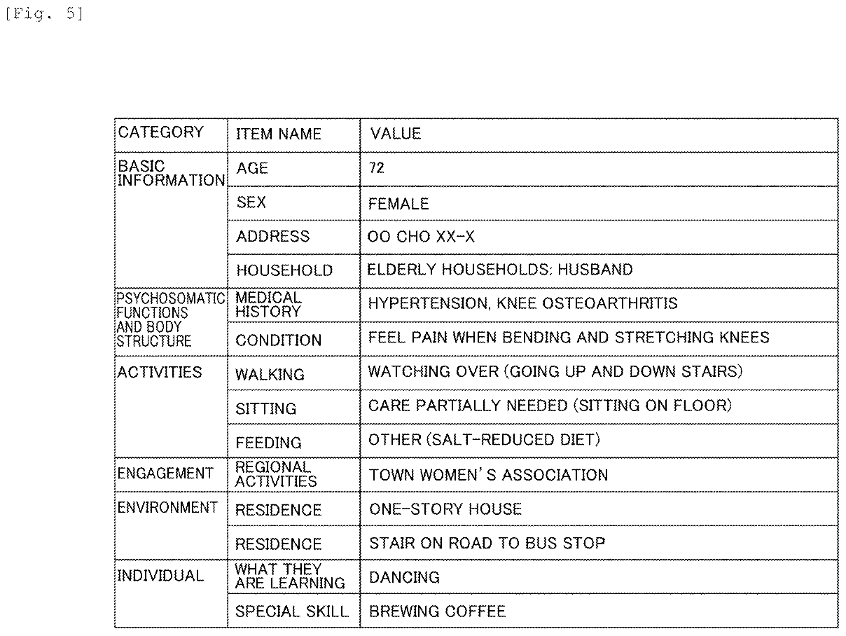

FIG. 5 is a diagram illustrating an example of adding a narrative item necessary for promoting social engagement to the personal data. To the personal data shown in FIG. 5, a category of “Individual” is added, and “What They Are Learning” and “Special Skill” are added as items (narrative items) belonging to the “Individual” category. That is, the narrative information extraction unit 12 adds the “Individual” category to the personal data of the care recipient A and also adds the item names and answers for the narrative items to the personal data in the format that belongs to the “Individual” category. FIG. 4 shows an example in which answers are received also for the job, type of occupation and family members living together, however for better understanding, only “What They Are Learning” and “Special Skill” are added in FIG. 5.

### [Expert Data Reference Unit 13]

The expert data reference unit 13 recognizes the personal data illustrated in FIG. 5 and an expert data group registered in the expert data storage unit 112 as inputs.

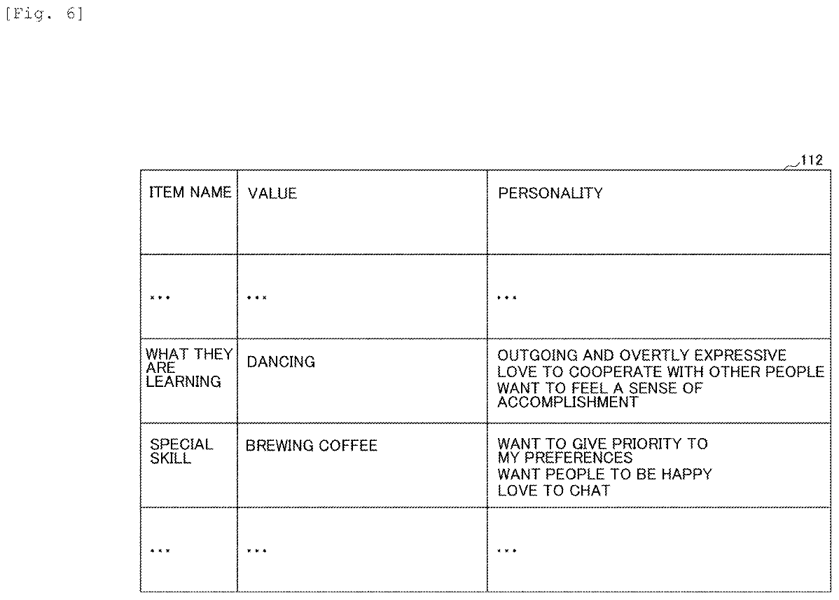

FIG. 6 is a diagram illustrating a configuration example of the expert data storage unit 112. As shown in FIG. 6, item names, values and personal relationships are stored in the expert data storage unit 112 for each narrative item. The data in one line in the expert data storage unit 112 will be hereinafter referred to as “expert data.”

“Personality” is information indicating a personality of a person corresponding to the item name and the value (their properties and characteristics). The expert data storage unit 112 may be created on the basis of conversations with experts.

The expert data reference unit 13 specifies expert data corresponding to an item name and a value of each record belonging to the “Individual” category of the personal data, and if any, adds the “Personality” in the expert data to the record.

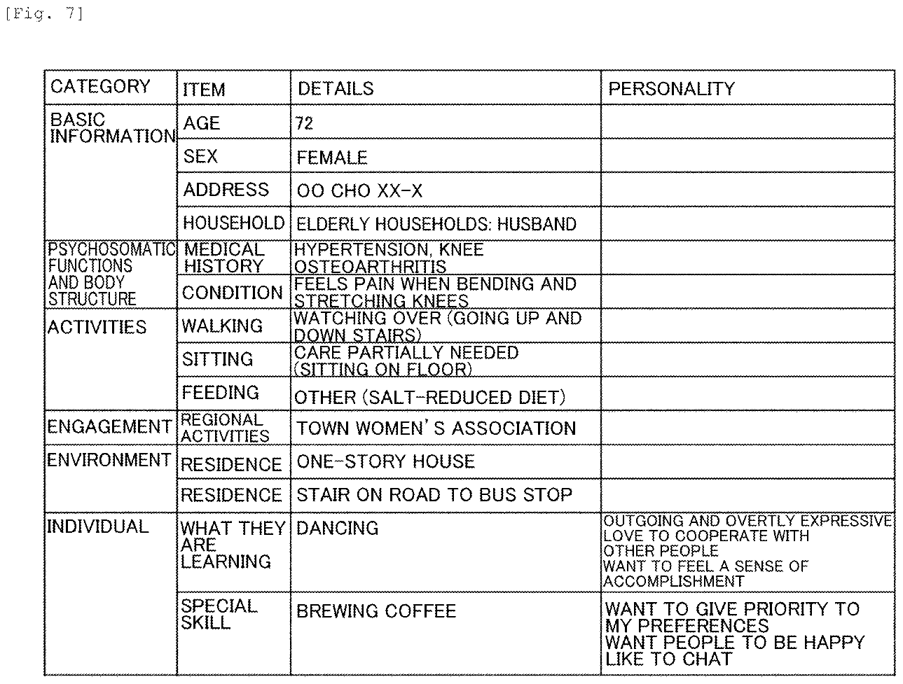

FIG. 7 is a diagram illustrating an example of adding “Personality” to the personal data. In the personal data shown in FIG. 7, a value of “Personality” is added to each of two records belonging to the “Individual” category. The “Personality” in a first record of the two records corresponds to a value of “Personality” in expert data (first expert data shown in FIG. 6) having the same item name and value as an item name (“What They Are Learning”) and value (“Dancing”) of the record. The “Personality” in a second record of the two records corresponds to a value of “Personality” in expert data (second expert data shown in FIG. 6) having the same item name and value as an item name (“Special Skill”) and value (“Brewing Coffee”) of the record.

### [Social Resource Input Unit 14]

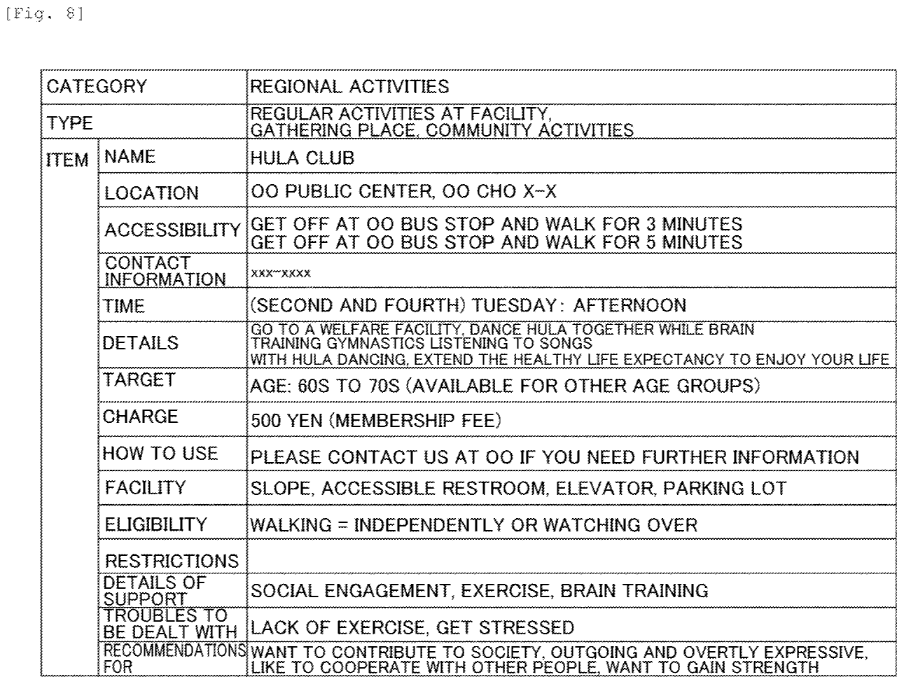

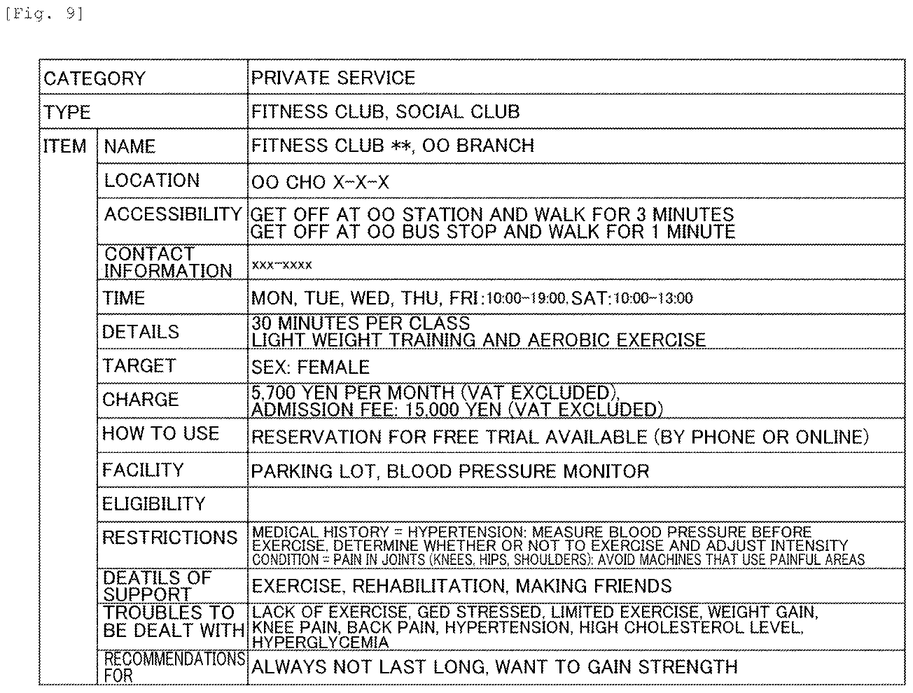

The social resource input unit 14 accepts social resource data input by a social resource provider for promoting social engagement or a local government officer known information on social resources, and registers the social resource data to the social resource data storage unit 113. The social resource data is data related to (indicating) the social resources. The social resources include facilities, services and activities available in daily life. FIG. 8 shows a first example of the social resource data, and FIG. 9 shows a second example of the social resource data.

As shown in FIGS. 8 and 9, the social resource data includes “Category”, “Type” and “Item” as components.

“Category” is a name of a social resource classified by the social resource provider and medical welfare system. A value of the “Category” may be selected from predetermined options (for example, medical institution, care service, comprehensive service, private service, and regional activities). Examples of the social resource provider include residents (e.g. neighborhood community associations), private companies, medical institutions, and administrative bodies (local governments). FIG. 8 shows an example of the social resource data in which a value of “Category” is “Regional Activities”, and FIG. 9 shows an example of the social resource data in which a value of “Category” is “Private Service.”

“Type” is a name assigned to an item included and subclassified in “Category.” A value of “Type” may be selected from predetermined options for the selected “Category.” FIG. 8 shows an example of the social resource data in which a value of “Type” is “Regular Activities at Facility, Gathering Place, Community Activities”, and FIG. 9 shows an example of the social resource data in which a value of “Type” is “Fitness Club, Social Club.”

“Item” is a set of components of detailed information on the social resource. Information constituting the “Item” may be different for each “Type.” In this case, an item list for each “Type” may be prepared in advance, and a value may be input to each item constituting the item list corresponding to the selected “Type.”

Examples of information constituting the “Item” include name, location, contact information, time, details, target, charge, how to use, facilities, eligibility, restrictions, details of support, troubles to be dealt with, and recommendations for a certain person.

The eligibility is input in a form of (conditional expression (eligibility=value)). The restrictions are input in a form of {conditional expression: restrictions}. The details of support, troubles to be dealt with and recommendations for a certain person can be, for example, selected from a predetermined list of options. However, it is also possible to add a new item if there is no corresponding answer option.

### [Query Input Unit 15 and Matching Unit 16]

Processing executed by the query input unit 15 and the matching unit 16 will be described with reference to a flowchart.

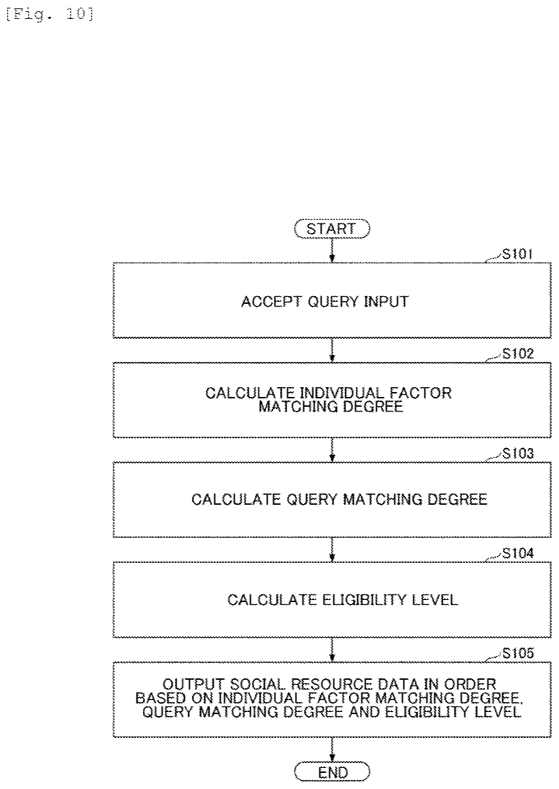

FIG. 10 is a flowchart illustrating one example of processing procedures of social resource match processing in response to a request from the care recipient A.

In step S101, the query input unit 15 accepts a query indicating a request for support desired by the care recipient A (support for promoting social engagement), which is input by the care recipient A or a person on behalf of the care recipient A (caregiver or family member) (hereinafter, a person who inputs the query will be referred to as a “user”).

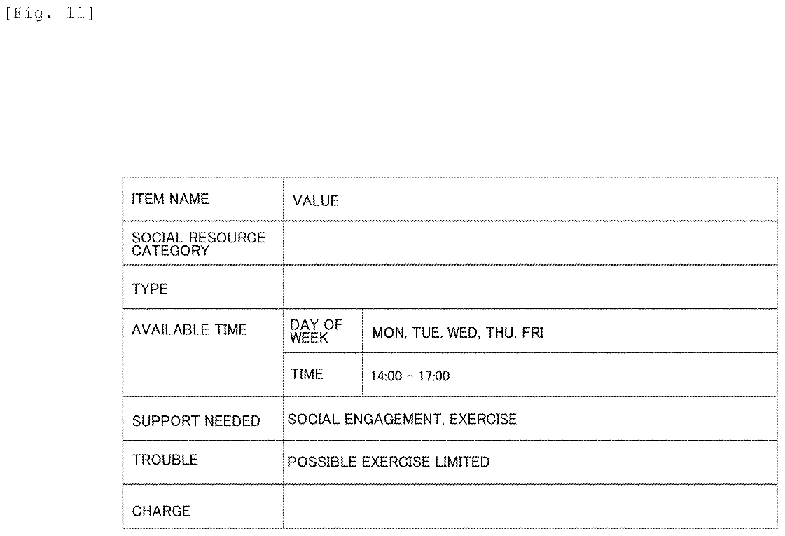

FIG. 11 is a diagram illustrating a configuration example of a query. As shown in FIG. 11, the query includes a “Social Resource Category”, “Type”, “Available Time and Day of the Week”, “Support Needed”, “Trouble” and “Charge.” The user inputs a value for at least one among these items.

“Social Resource Category” is a condition corresponding to the “Category” contained in the social resource data. “Type” is a condition corresponding to the “Type” contained in the social resource data. “Available Time and Day of the Week” indicates a time and day of the week that the care recipient A can participate in (or use) the social resource, which is a condition corresponding to the “Time” contained in the social resource data. “Support Needed” is a condition corresponding to the “Details of Support” contained in the social resource data. “Trouble” is a condition corresponding to the “Troubles to Be Dealt with” contained in the social resource data. “Charge” indicates the amount of money that the care recipient A can pay when using the social resource, which is a condition showing an upper limit for the “Charge” contained in the social resource data.

Items constituting the query are not limited to those shown in FIG. 11. Since the query is data serving as a search term for social resources, any items may constitute the query as long as they are related to the social resource data (FIGS. 8 and 9).

The matching unit 16 calculates, for each social resource (that is, for each piece of social resource data), the number of values (hereinafter referred to as “individual factor matching degree”) matching values registered in the “Personality” included in the personal data, among those registered in the “Recommendations for” included in the social resource data (step S102). For example, the matching unit 16 calculates an individual matching degree for each social resource according to the following procedure.

First, the matching unit 16 extracts information on “Personality” from the personal data. According to the example of the personal data shown in FIG. 6, the following information is extracted as the “Personality.” Personality=[Outgoing and overtly expressive, Love to cooperate with other people, Want to feel a sense of accomplishment, Want to give priority to my preferences, Want people to be happy, Love to chat]

The matching unit 16 extracts values included in the “Personality” out of values in the “Recommendations for” included in each piece of the social resource data, as “Matching Desire.” The item “Recommendations for” included in the social resource data is information indicating a person for whom a social resource related to the social resource data is recommended. “Outgoing and overtly expressive” and “Love to cooperate with other people” are extracted from the item “Recommendations for” included in the social resource data shown in FIG. 3, as corresponding values. Meanwhile, the item “Recommendations for” included in the social resource data shown in FIG. 9 has no corresponding value. Therefore, for example, the following data is extracted. Output={“Hula Club”, Matching Desire: [“Outgoing and overtly expressive”, “Love to cooperate with other people” ] }, (“Fitness Club**, 00 Branch”, Matching Desire:) In the data, the extraction result is expressed in the format of {“<Name>”, Matching Desire: <Values extracted from the item “Recommendations for”> for each piece of social resource data. Extraction of a value included in the “Personality” among the values of the item “Recommendations for” for each piece of social resource data may be performed on the basis of determination on whether character strings match, or determination on whether nouns and verbs are the same by morphological analysis.

The matching unit 16 recognizes the number of “Matching Desire” for each piece of social resource data as an individual factor matching degree. According to the example of “Output” described above, the respective individual factor matching degrees of the social resource data (“Hula Club”) shown in FIG. 8 and the social resource data (“Fitness Club **, 00 Branch”) shown in FIG. 9 are as follows:

### <Individual Factor MatchingDegree>

### Hula Club=2

### Fitness Club**, 00 Branch=0

Following step S101, the matching unit 16 compares, for each piece of social resource data, a value of each item included in a query input by the query input unit 15 with a value of an item corresponding to the query in the social resource data, and then calculates the number of values (hereinafter referred to as “query matching degree”) that match values of the items included in the social resource data, among values included in the query (step S103).

In this embodiment, items of the social resource data (hereinafter referred to as “social resource data item”) correspond to items of the query (hereinafter referred to as “query item”) as follows:
“Social Resource Category”→“Category”
“Type”→“Type”
“Available Time”→“Time”
“Support Needed”→“Details of Support”
“Trouble”→“Troubles to Be Dealt with”
“Charge”→“Charge”

The correspondence relationships above are stored in advance in the auxiliary storage device 102, for example.

The matching unit 16 determines whether a value of the query item with specified values matches a value of the social resource item corresponding to the query item, and calculates the number of matching values as a query matching degree.

Specifically, in a case where the query is as shown in FIG. 11, the specified values are for the “Available Time”, “Support Needed” and “Trouble.” Therefore, the matching unit 16, for each piece of the social resource data (“Hula Club”) shown in FIG. 8 and the social resource data (“Fitness Club **, 00 Branch”) shown in FIG. 9, compares a value of the “Available Time” in the query with the value of the “Time” in each piece of social resource data; compares a value of the “Support Needed” in the query with the value of the “Details of Support” in each piece of social resource data; and compares a value of the “Trouble” in the query with the value of the “Trouble to Be Dealt with” in each piece of social resource data. Consequently, the number of matching values for the “Available Time”, “Support Needed” and “Trouble” is as follows for each piece of the social resource data (“Hula Club”) shown in FIG. 8 and the social resource data (“Fitness Club**, 00 Branch”) shown in FIG. 9:

Available Time: Hula Club=1, Fitness Club**, 00 Branch=1 Support Needed: Hula Club=2, Fitness Club**, 00 Branch=1 Trouble: Hula Club=0, Fitness Club**, 00 Branch=1 The matching unit 16 calculates the sum of the number of matching values for each piece of social resource data as the query matching degree for the social resource data. Therefore, the respective query matching degrees of the social resource data (“Hula Club”) shown in FIG. 8 and the social resource data (“Fitness Club**, 00 Branch”) shown in FIG. 9 are as follows:

### <Query MatchingDegree>

### Hula Club=1+2+0=3

### Fitness Club**, 00 Branch=1+1+1=3

It is also possible to specify a query item which is important for the user at the time when the query is input, relatively set the weight to the important query item, and calculate the weighted sum of the number of matching items as the query matching degree.

Following step S103, the matching unit 16 calculates, for each piece of social resource data, eligibility (hereinafter referred to as “eligibility level”) of the care recipient A for using (or participating in) the social resource related to the social resource data (step S104). Calculation processing of eligibility level consists of the following procedures (1), (2) and (3).

(1) The matching unit 16 compares, for each piece of social resource data, each of the items “Target”, “Eligibility” and “Restrictions”, conditions to determine whether a certain person is eligible to use (or participate in) the social resource related to the social resource data, with the personal data (FIG. 7), and assigns an evaluation value for each item to the social resource data. How to assign evaluation values for these items is as follows:

### “Target”

For a value of the “Target” in the social resource data, which is expressed as (Component: Value), the matching unit 16 extracts a value of an item corresponding to the “Component” from the personal data. For example, when a value of the “Target” is expressed as (Sex: Female), the matching unit 16 extracts a value of the “Sex” among items included in the personal data, and assigns an evaluation value to the social resource data depending on whether it matches to a value in the social resource data (“Value” in {Component: Value}). For example, the matching unit 16 assigns “1” when they match, and otherwise “0.” In a case where a specific area (for example, a region or school district”) is the “Component”, the matching unit 16 may convert a value of the “Address” included in the personal data to an area based on an address-to-area conversion table prepared in advance, thereby comparing with a value included in the social resource data. In a case where the personal data is as shown in FIG. 7, evaluation values regarding the “Target” and assigned respectively to the social resource data (“Hula Club”) shown in FIG. 8 and the social resource data (“Fitness Club**, 00 Branch”) shown in FIG. 9 are as follows:

Target: Hula Club=1, Fitness Club**, 00 Branch=1 That is, since a value of the “Age” included in the personal data (FIG. 7) matches {Age: 60 s to 70 s (available for other age groups)} of the “Target” included in the social resource data (“Hula Club”) shown in FIG. 8, 1 is assigned to the social resource data (“Hula Club”). Further, since a value of the “Sex” included in the personal data (FIG. 7) matches {Sex: Female} of the “Target” included in the social resource data (“Fitness Club**, 00 Branch”) shown in FIG. 9, 1 is assigned to the social resource data (“Fitness Club**, 00 Branch”).

### “Eligibility”

The matching unit 16 determines, in a case where an item name of any item belonging to the “Psychosomatic Functions and Body Structure” category or “Activities” category, included in the personal data, matches a left side of a conditional expression of the “Eligibility” included in the social resource data, the conditional expression of the “Eligibility” based on the value of such an item. The matching unit 16 assigns “1” as an evaluation value to the social resource data in a case where the conditional expression is true, and assigns “0” as an evaluation value to the social resource data in a case where the conditional expression is false. Further, in a case where there is no item related to an item name matching the left side of the conditional expression among items belonging to the “Psychosomatic Functions and Body Structure” category or “Activities” category, included in the personal data, the matching unit 16 assigns “1” as an evaluation value to the social resource data. Matching between the left side and the item name, or determination on whether the conditional expression is true or false may be determined by comparing strings, or by performing morphological analysis and determining whether common nouns are included.

In a case where the personal data is as shown in FIG. 7, evaluation values regarding the “Eligibility” and assigned respectively to the social resource data (“Hula Club”) shown in FIG. 8 and the social resource data (“Fitness Club**, 00 Branch”) shown in FIG. 9 are as follows: Eligibility: Hula Club=1, Fitness Club**, 00 Branch=1 That is, since the conditional expression is true for the “Eligibility” included in the social resource data (“Hula Club”) shown in FIG. 8, based on a value of the “Walking” included in the personal data, 1 is assigned to the social resource data (“Hula Club”). Further, since the conditional expression is not set up for the “Eligibility” included in the social resource data (“Fitness Club**, 00 Branch”) shown in FIG. 9 (that is, the eligibility is not limited), 1 is assigned to the social resource data (“Fitness Club**, 00 Branch”).

### “Restrictions”

The matching unit 16 determines, in a case where an item name of any item belonging to the “Psychosomatic Functions and Body Structure” category or “Activities” category, included in the personal data, matches a left side of a conditional expression of the “Restrictions” included in the social resource data, the conditional expression of the “Restrictions” based on the value of such an item. The matching unit 16 assigns “0.8” as an evaluation value to the social resource data in a case where the conditional expression is true, and assigns “1” as an evaluation value to the social resource data in a case where the conditional expression is false. Further, in a case where there is no item name matching the left side of the conditional expression among items belonging to the “Psychosomatic Functions and Body Structure” category or “Activities” category, included in the personal data, the matching unit 16 assigns “1” as an evaluation value to the social resource data.

In a case where the personal data is as shown in FIG. 7, evaluation values regarding the “Restrictions” and assigned respectively to the social resource data (“Hula Club”) shown in FIG. 8 and the social resource data (“Fitness Club**, 00 Branch”) shown in FIG. 9 are as follows:

Restrictions: Hula Club=1, Fitness Club**, 00 Branch=0.8 That is, since the conditional expression is not set up for the “Restrictions” included in the social resource data (“Hula Club”) shown in FIG. 8, 1 is assigned to the social resource data (“Hula Club”). Meanwhile, since the conditional expression is true for the “Restrictions” included in the social resource data (“Fitness Club**, 00 Branch”) shown in FIG. 9, based on a value of the “Medical History” included in the personal data, 0.8 is assigned to the social resource data (“Fitness Club**, 00 Branch”).

(2) The matching unit 16 assigns, for each piece of social resource data, an evaluation value to the social resource data, based on determination on whether a value of the “Accessibility” included in the social resource data matches restrictions indicated by the “Psychosomatic Functions and Body Structure”, “Activities” and “Environment” categories of the personal data.

Specifically, in a case where the “Accessibility” included in the social resource data does not contain a notation “Pick-up Service”, and an item with a name of “Walking” is contained in the “Activities” category included in the personal data (FIG. 7) but its value is neither “Independently” nor “Watching over”, the matching unit 16 assigns 0.5 as an evaluation value to the social resource data, and if otherwise, assigns 1 as an evaluation value to the social resource data. In the personal data is as shown in FIG. 7, evaluation values regarding the “Target” and assigned respectively to the social resource data (“Hula Club”) shown in FIG. 8 and the social resource data (“Fitness Club**, 00 Branch”) shown in FIG. 9 are as follows: Accessibility: Hula Club=1, Fitness Club**, 00 Branch=1 (3) The matching unit 16 calculates, for each piece of social resource data, the eligibility level for the social resource data by multiplying the evaluation values assigned to the social resource data in (1) and (2). In the example above, the eligibility levels of the social resource data (“Hula Club”) shown in FIG. 8 and the social resource data (“Fitness Club **, 00 Branch”) shown in FIG. 9 are as follows:

### Eligibility Level:

### Hula Club=1*1*1*1=1

### Fitness Club**, 00 Branch=1*1*1*0.8=0.8

Following step S104, the matching unit 16 aligns the social resource data based on the individual factor matching degree, the query matching degree and the eligibility level, and outputs the social resource data in the order of alignment (step S105).

Specifically, the matching unit 16 calculates, for the social resource data with the eligibility level >0, the sum of the individual factor matching degree and the query matching degree as a matching degree of the social resource data for the query and the personal data, and aligns the social resource data in the descending order of the sum. In this case, predetermine weights α and β may be given to each of the individual factor matching degree and the query matching degree to calculate a weighted sum (matching degree).

In the example above, sets, i.e. (individual factor matching degree, query matching degree, eligibility level), of the social resource data (“Hula Club”) shown in FIG. 8 and the social resource data (“Fitness Club**, 00 Branch”) shown in FIG. 9 are as follows:

### Hula Club=(2,3,1)

### Fitness Club**, 00 Branch=(0, 3, 0.8)

Those two pieces of social resource data both have the eligibility level >0. Therefore, the matching unit 16 calculates the weighted sum of the matching degree (matching degree) for each of two pieces of social resource data as follows:

Weighted Sum of Hula Club=2α+3βWeighted Sum of Fitness Club**, 00 Branch=0*α+3βIn a case where α is 1 and β is 1, the weighted sums of “Hula Club” and “Fitness Club**, 00 Branch” are as follows: Weighted Sum of Hula Club=2+3=5

Weighted Sum of Fitness Club**, 00 Branch=0+3=3

Therefore, they are aligned in the descending order of the weighted sum as follows:

### 1. Hula Club, 2. Fitness Club**, 00 Branch

The matching unit 16 output the alignment result as above. In a case where several pieces of social resource data have the same weight sum, the matching unit 16 aligns the several pieces of social resource data in the descending order of the matching degree. That is, in this case, the eligibility level is also reflected in the matching degree between the query and the social resource data.

Further, the matching unit 16 may, for example, add colors to matching items found in the calculation of the individual factor matching degree or the query matching degree for the social resource data aligned (as shown in FIGS. 8 and 9) when the alignment result is output. In this case, for example, for the “Hula Club” (FIG. 8), “Outgoing and overtly expressive” and “Love to cooperate with other people” included in the “Recommendations for”, “TUE: Afternoon” included in the “Time”, and “Social Engagement” and “Exercise” included in the “Details of Support” are colored differently from other items when outputting. Accordingly, the background why the specific social resource data is recommended can be presented to the care recipient A.

Further, the matching unit 16 extracts, in a case where the social resource data has a matching degree lower than 1 (hereinafter referred to as “target social resource data”), item (“Target”, “Eligibility”, “Restrictions” and “Accessibility”) which lower the matching degree of the target social resource data (i.e. have a value <1). If those items include “Eligibility” or “Accessibility”, “Support Needed” and “Trouble” included in the original query are replaced by values of such items to make a new query, and step S103 and subsequent steps are executed with the new query. In this case, if an item included in the personal data and matching the “Item” in the “Eligibility” belongs to the “Psychosomatic Functions and Body Structure” category, the matching unit 16 sets the “Eligibility” to the “Trouble” included in the new query. Meanwhile, if an item included in the personal data and matching the “Item” in the “Eligibility” belongs to the “Activities” category, the matching unit 16 sets the value of the “Eligibility” to the “Support Needed” included in the new query. Moreover, if an item included in the personal data and matching the “Item” in the “Accessibility” is the item “Walking” in the “Activities” category, the matching unit 16 sets the value of “Accessibility” to the “Support Needed” included in the new query.

If any pieces of social resource data has the query matching degree of 1 or higher and the eligibility level >0 when step S103 and subsequent steps are executed with the new query, the matching unit 16 may output the social resource data having the greatest query matching degree (and if several pieces of social resource data have the greatest query matching degree, the one with the greatest eligibility level) along with the target social resource data.

Even in a case where there are any restrictions (for example, “Walking=care partially needed”) in the access to the social resource related to the target social resource data, the new query can enable to find out a social resource (e.g. on-demand taxi) providing aid for walking. Thus it is possible to output the target social resource data with restricted access, but along with a complementary social resource such as the on-demand taxi, thereby offering various options in a wider range to care recipients.

As described above, according to the present invention, a person who needs support can get full visualization of available social resources for promoting social engagement, which match the personality of them, only by inputting a query. Therefore, it is possible to enable anyone to easily find out proper support for promoting social engagement.

In the present embodiment, the social resource presentation device 10 may be a terminal used by a person who inputs a query, or a server computer connected to the terminal via a network. In a case where the social resource presentation device 10 is the terminal, a program that causes the terminal to function as the social resource presentation device 10 is distributed or downloaded to the terminal via a network, and then installed in the terminal. In this case, the query input unit 15 displays a query input screen on a display device (e.g. LCD display) of the terminal and accepts a query input through the input screen. The matching unit 16 displays (outputs) the aligned social resource data on the display device.

On the other hand, in a case where the social resource presentation device 10 is the server computer, the query input unit 15 controls the terminal via a network to display a query input screen on the terminal, and accepts a query input through the input screen from the terminal via the network. The matching unit 16 transmits (outputs) the aligned social resource data to the terminal via the network, and thereby causes the terminal to display the aligned social resource data. For example, HTTP (Hypertext Transfer Protocol) may be used for controlling the terminal via the network by the server computer.

In the present embodiment, the query input unit 15 is one example of the input unit. The matching unit 16 is one example of a comparison unit and an output unit. The social resource data is one example of the first data. The personal data is one example of the second data.

Although the embodiments of the present invention have been described in detail above, the present invention is not limited to these particular embodiments, and various modifications and changes are possible within the scope of the present invention described in claims.

### REFERENCE SIGNS LIST

10: Social resource presentation device
11: Physical information classification unit
12: Narrative information extraction unit
13: Expert data reference unit
14: Social resource input unit
15: Query input unit
16: Matching unit
100: Drive device
101: Recording medium
102: Auxiliary storage device
103: Memory device
104: CPU
105: Interface device
111: Personal data storage unit
112: Expert data storage unit
113: Social resource data storage unit
B: Bus

1. A social resource presentation device comprising:
a processor; and
a memory storing program instructions that cause the processor to:
receive a request input by a user related to support for promoting social engagement; and
output information indicating a social resource corresponding to characteristics and the request of the user.

2. The social resource presentation device according to claim 1, wherein the program instructions cause the processor to
compare, for each social resource, first data stored regarding the social resource, second data stored regarding the user, and the request, and
output information indicating the social resource based on the comparison result.

3. The social resource presentation device according to claim 2, wherein the program instructions cause the processor to
compare information included in the first data and indicating a person to whom the social resource is recommended, and information included in the second data and indicating the characteristics of the user, and compare a value of a first item constituting the request and a value of a second item corresponding to the first item, among all items constituting the first data, thereby calculating a matching degree of the request and the first data with the second data, and
output the first data in descending order of the matching degree.

4. The social resource presentation device according to claim 3, wherein the program instructions cause the processor to
calculate the matching degree by comparing a value of a first item constituting the request and a value of a second item corresponding to the first item, among all items constituting the first data.

5. The social resource presentation device according to claim 3, wherein the program instructions cause the processor to
calculate the matching degree by comparing information included in the first data and indicating a condition for using the social resource with the second data.

6. A social resource presentation method executed by a computer, the social resource presentation method comprising:
receiving a request input by a user related to support for promoting social engagement; and
outputting information indicating a social resource corresponding to characteristics and the request of the user.

7. A non-transitory computer-readable recording medium storing a program for causing a computer to execute:
receiving a request input by a user related to support for promoting social engagement; and
outputting information indicating a social resource corresponding to characteristics and the request of the user.

8. The non-transitory computer-readable recording medium according to claim 7, wherein
the request input is received via a network in the receiving, and
the information indicating the social resource is output via a network in the outputting.
